(19) United States
(12) Patent Application Publication
(10) Pub. No.: US 2004/0087356 A1
(43) Pub. Date: May 6, 2004

(54) Methods and apparatuses for gaming

(76) Inventor: Jonathan Douglas Collins, Danville, CA (US)

Correspondence Address: HOLLAND & HART, LLP, 555 17TH STREET, SUITE 3200, DENVER, CO, 80201, US

(21) Appl. No.: 10/286,542

(22) Filed: Nov. 1, 2002

(51) Int. Cl. A63F 9/24; A63F 13/00; G06F 17/00; G06F 19/00

(52) U.S. Cl. 463/17

(57) ABSTRACT

The present invention provides a game having a grid with a plurality of rows and columns. The intersection of the rows and columns form grid blocks that represent a defined time in an event An outcome that may occur at the defined time is predetermined and inserted into the grid blocks. If the predetermined outcome at the defined time actually occurs, a prize is awarded

### FIELD OF THE INVENTION

The present invention relates to games of chance and, more particularly, to providing cards, tickets, graphical user interfaces, Internet web pages, World Wide Web sites, local and wide area network, or the like having a predetermined number of potential outcomes and awarding prizes, incentives, or the like based on actual outcomes

### BACKGROUND OF THE INVENTION

With increases in ticket prices, labor unrest, contraction, drug use, and hosts of other problems, the desirability to view and participate in professional sporting events has been dwindling in the United States and the world. For example, baseball labor negotiations in the United States almost caused the 9^{th} work stoppage since about 1972, which pushed attendance at baseball games down for this year and may for years to come

In order to combat the downward trend of interest in professional sporting events, many professional and non-professional sports teams develop promotional and marketing campaigns For example, ball teams have various races with mascots, such as the sausage races at Miller Park in Milwaukee, Wis., digital races on the “big screens”, such as the bike hat derby at Coors Field in Denver, Colo. Other sport venues have similar style games for football, hockey, and the like These promotional games have limited value, however, as they are one-shot deals, and generally do not provide sufficient entertainment to maintain fan interest and attendance in the sporting event. Thus, to the extent the fan attends the event and participates in the promotional game, the fan may leave after the promotional game or arrive slightly before the promotional game Thus, these games generally have been a failure in increasing fan viewing, whether actual attendance at a ballpark or reception of an event broadcast.

Because the general gimmicks used by most sporting events are unrelated to the sport or event taking place, many attempts have been made to develop games of chance to enhance interest in the game being played Many of these games fall short of the goal in that they are overly complex or too simplistic

For example, U.S. Pat. No. 4,883,636, issued on Nov. 28, 1989 to Fantle, Jr , titled BASEBALL BINGO GAME, relates to a game that uses a playing card having a series of zones For baseball, the game has nine rows and columns to indicate the innings in a game. Each square has an event that takes place in an inning When a play takes place that corresponds to an event for either the home or away team in an inning, a marker is placed on the table In other words, this is a simple bingo game where the baseball plays are used instead of drawing numbers from a bin

Just as the BASEBALL BINGO GAME seems simple and unrelated to the game being played, other games, such as U.S. Pat. No. 5,782,470, issued on Jul. 21, 1998 to Langan, titled SPORTS GAME OF SKILL AND CHANCE, seem overly complex and detailed The SPORTS GAME OF SKILL AND CHANCE relates to a game using a tic-tac-toe style game board to award prizes In this game, the user needs to predict each player at bat to determine if, for example, the right fielder will get a double in the 5^{th} inning This game requires complex knowledge of statistics for individual performers as well as the ability to predict what batters play at what positions will likely bat in a given inning

Numerous other sports-related games of chance have previously been proposed, none of these games is particularly suitable for use with an on-going event, in particular athletic events Alternative bingo-style games are disclosed in U.S. Pat. Nos. 3,549,150 to Weeks; and 4,169,601 to Frischmann, et al. Bingo-type promotional games have also been proposed that use promotional coupons published, for example, in newspapers Promotional games are disclosed in U.S. Pat. Nos. 4,509,759, 4,619,457 and 4,711,454 to Small. One example of such a game is disclosed in U.S. Pat. No. 4,706,959 to Price for a quarterback draw football game

U.S. Pat. No. 4,184,270 to Presbrey, describes a device used in conjunction with a broadcast golf game, the device is simply a visual aid and is not a game of chance U.S. Pat. No. 5,112,050 to Koza, et al discloses a broadcast lottery in which a player acquires a ticket from a transmitter location. The stored information is compared to the broadcast information and, if a match results, the ticket is deemed to be a winning ticket However, the game is simply a lottery game where the plays of an event are used instead of numbered balls in a conventional lottery Thus, their fans are not encouraged to attend or even view the event

In U.S. Pat. No. 5,332,218 and 5,043,889 to Lucey, a golf sweepstakes game is disclosed in which contestants predict the winner and runners-up of a golf tournament Sweepstakes prizes are awarded depending upon the accuracy of the contestants' predictions. The contestants are each provided with a game card having an access number, and a code system allows the contestants to convert their selections into numbers which are input to a computer system along with the contestants' respective access number. The results of the golf tournament are entered into the computer system, and the winner of the sweepstakes is determined in accordance therewith

In U.S. Pat. No. 1,639,894, a game or puzzle based on baseball is disclosed in which a score card is formed with a series of columns The first column lists the players of a team while the remaining nine columns each represent a different inning A guide is provided for defining codes for different plays, each of which can only be used once on the score card Some innings are blocked out for each of the players. The contestant fills in the blank spaces for each player in the available innings in an effort to obtain the greatest number of runs while completing a perfect score card The game is relatively difficult to understand, complex to play, highly unrealistic, and does not serve to enhance spectator interest or enthusiasm by allowing spectators to make predictions of the individual performance of selected athletes

Therefore, it would be desirous to have a game that promotes interest in the entire event, entertains, and is not overly complex

### SUMMARY OF THE INVENTION

To attain the advantages of and in accordance with the purpose of the present invention, an apparatus and method for gaming is provided The game comprises a game grid having a plurality of rows and columns such that the intersection of the rows and columns form grid blocks that represent a defined time in an event. An outcome that may occur at the defined time is predetermined and inserted into the grid blocks. If the predetermined outcome at the defined time actually occurs, a prize is awarded

The foregoing and other features, utilities and advantages of the invention will be apparent from the following more particular description of a preferred embodiment of the invention as illustrated in the accompanying drawings

### BRIEF DESCRIPTION OF THE DRAWING

The above and other objects and advantages of the present invention will be apparent upon consideration of the following detailed description, taken in conjunction with the accompanying drawings, in which like reference characters refer to like parts throughout, and in which.

FIG. 1 is a prior art baseball game ticket;

FIG. 2 is a baseball game ticket illustrative of the present invention,

FIG. 3 is a game grid illustrative of the present invention,

FIG. 4 is a legend useful with the game grid of FIG. 3,

FIGS. 5 and 6 are additional game grids illustrative of the present invention;

FIG. 7 is a processor based game grid illustrative of computer systems consistent with the present invention;

FIG. 8 is a flowchart illustrative of a methodology according to the present invention;

FIG. 9 is a sample game grid illustrative of the present invention; and

FIGS. 10, 11, and 12 are still more game grids illustrative of the present invention

### DETAILED DESCRIPTION

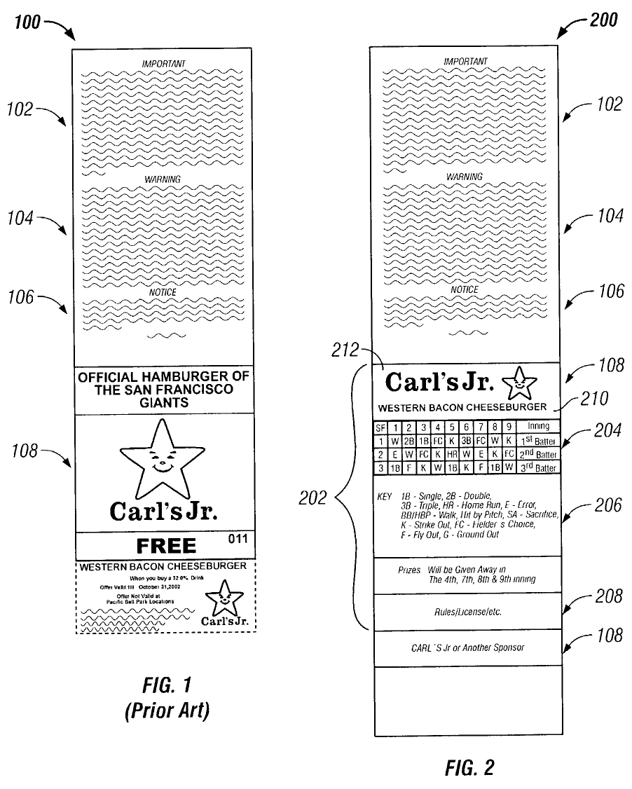

FIGS. 1-12 illustrate methods and apparatuses of gaming consistent with aspects of the present invention. While the present invention will be described with reference to a baseball game, one of ordinary skill in the art will understand that other events could be substituted for a baseball game without departing from the spirit and scope of the present invention Moreover, several examples of alternative events will be provided When alternatives or examples are provided, those examples should be deemed to be exemplary and non-limiting examples

FIG. 1 is exemplary of a prior art baseball game ticket 100 Conventionally, ticket 100 includes, a license section 102, a warning section 104, a notice section 106, and an advertisement space 108 License section 102 explains the rights and privileges a fan obtains by purchase of the ticket Warning section 104 includes information relating to risks associated with attending the event, which include, for example, being hit by a baseball Notice section 106 includes information regarding refunds Advertisement section 108 includes an advertisement by the sponsor of the event, which in this example is Carl's Jr., Inc. Of course, the arrangement and particular sections of ticket 100 are exemplary and more, less, or different section types could be used

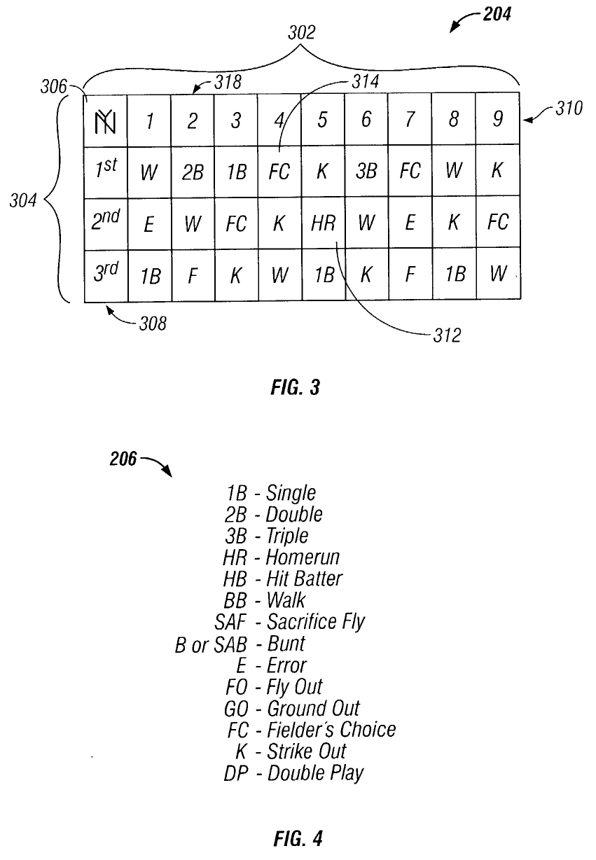

Shown in FIG. 2 is a baseball game ticket 200 consistent with the present invention Baseball game ticket 200 is similar to conventional ticket 100 and generally will include license section 102, warning section 104, and notice section 106 However, advertisement section 108 may be replaced or augmented by game section 202 For a baseball game, game section 202 includes a game grid 204 (shown in more detail in FIG. 3), a legend 206 (shown in more detail in FIG. 4), rule section 208, which may also be referred to as game instructions, scoreboard instructions, or the like, and prize section 210. More, less, or other game parts are possible with the above being exemplary Rule section 208 generally includes written or other instructions regarding how to play the game Prizes section 210 may include what prizes can be won for given combinations, etc. Game section 202 may include one or more separate advertisement sections 212

FIG. 3 shows game grid 204 in more detail Game grid 204 could be laid out in various ways, but it has been found a grid containing a plurality of columns 302 and a plurality of rows 304 works well. In this case, a baseball game contains 9 innings, and 9 columns 302 exist, 1 for each inning More or less innings could be included. For example, innings 10, 11, 12, or more could be included to account for extra-inning games Alternately, innings in which prizes are awarded, such as, for example, the 4^{th}, 7^{th}, 8^{th}, and 9^{th} innings, may be the only innings included Each turn at bat has at least 3 batters (1 for each out), and 3 rows 304 exist for each of the minimum batters More or less batters could be identified for each inning. For example, prizes may only be awarded based on the second batter for each inning, in which case only a row for the second batter may exist Alternatively, particular batters, such as Barry Bonds and Jeff Kent of the San Francisco GIANTS, may be identified Still alternatively, if the average number of at bats per inning is 5 at bats, 5 rows may be provided Other combinations are possible

Grid 204 may contain a representation of the home teams logo, such as the New York Yankees logo in block 306. In this case, the grid 204 contains column 308 indicating the batters for the game, and the logo. Grid 204 also contains row 310 that contains the innings for the game and the logo. The remaining blocks are filled in with potential outcomes, a possible legend associated with the outcomes regarding baseball is shown in FIG. 4 Thus, if a prize batter is the second batter of the 5^{th} inning, the ticket wins if the batter hits a homerun, as shown by grid block 312. Typically, the grid is filled in prior to purchase, however, it would be possible to arrange a system that has a user input results, such as a conventional lottery ticket purchase where either random numbers are assigned or user selected outcomes are assigned Using the first three batters of an inning provides some additional incentive to watch the event because, for example, the 2^{nd} batter of the 4^{th} inning always comes to bat If, however, the tickets indicated a particular player, such as, for example, Sammy Sosa, he may only bat a few times a game or not even play, which may diminish the effectiveness of the game

Prize combinations for the present invention are almost limitless For example, the homerun exemplified above may get a prize If a match occurs for the entire inning, a better or different prize may be awarded, such as, for example, if in inning 5 the first batter strikes out, the second batter hits a homerun, and the third batter hits a single. Alternatively, if the 2^{nd} batter of each inning generates a match, as still different prizes may be awarded, etc Also, while ticket 200 shows prizes being awarded in particular, innings, if prizes were randomly awarded, a greater incentive to watch the game would be given because of the possibility of winning a prizes could occur at any moment

The effectiveness of the game may be increased from inning-to-inning by randomly assigning innings to a home team or a visiting team, although any combination would be possible. For example, inning 3 may be assigned to the home team such that if the 1^{st} batter hits a single, a prize is awarded However, inning 4 may be a visiting team inning such that if the 3^{rd} batter of the visiting team draws a walk, a prize is awarded, etc.

Continuing the baseball example, FIG. 4 shows a sample legend 206 usable with game grid 204 In this case, 14 possible outcomes are provided. Also, due to relative probabilities, such as a single is more likely than a homerun, prizes can be awarded differently for different results. Further, other designators are possible, such as, for example, a simple O for out instead of separating outs into strike outs, ground outs, fly outs, fielder's choice, etc, or an H for a hit instead of singles, doubles, etc

On reading the disclosure above, one of ordinary skill in the art would understand many variations of the above game could be accomplished. For example, game grid 204 currently represents offensive categories, but the game could be defensive. In this example, 1^{st}, 2^{nd}, and 3^{rd} rows 304 could represent the 1^{st}, 2^{nd}, and 3^{rd} outs of an inning The fielder's choice in grid block 314 could instead be GO 4-3 indicating the out was a ground out from the second baseman to the first baseman

While many outcomes and ticket generation processes could be used, it has been found that application of simple probability equations would help a potential game supporter to determine potential costs associated with winning tickets. Continuing with the baseball example, and referring to FIG. 9, a sample determination is made In this case, the probable outcomes are equally weighted to be either a hit or an out for convenience, although one of ordinary skill in the art would understand some outcomes are more likely than other outcomes, such as, it is more likely any given at bat will end in an out than a hit. In any event, FIG. 9 shows a grid 900 using columns for nine innings and rows for three batters Assume prizes are awarded for matches when Batter I gets a hit in innings 6 and 9, Batter 2 gets a hit in inning 3, and Batter 3 gets an out in inning 8. Thus, the probability of a ticket winning can be determined by the following formula

Probability=1/[o^{r}×ₙC₄],

where o is the number of possible outcomes (in this case 2, hit or out), r is the number of matches (in this case 4), n is the total number of positions (in this case 27). Thus, for this example,

Probability=1/[2⁴×₂₇C₄].

Of course, while convenient to be able to determine the number of winning tickets, tickets do not have to be generated with any winning combinations in mind In fact, the joy of the game may increase if the winning spots are randomly announced during the game

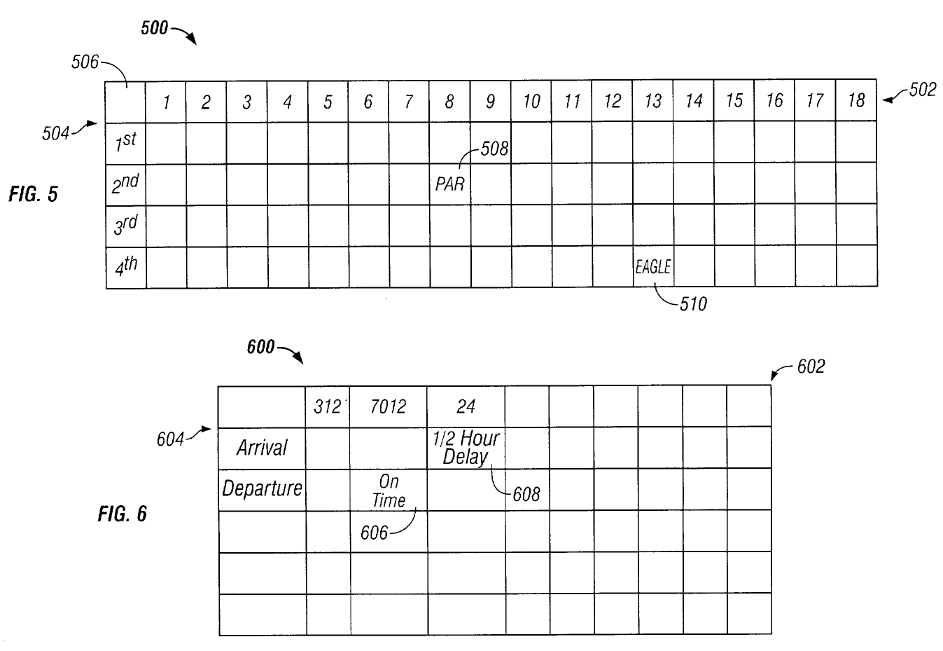

One of ordinary skill in the art on reading the above disclosure would also recognize that other games or events could benefit from the present invention For example, FIG. 5 shows a game grid 500 associated with a golf game Grid 500 includes a plurality of columns 502 and a plurality of rows 504 In this example, 1 column 502 exists for each hole on a golf course (1-18). Further, 4 rows 504 are shown, 1 for the first 4 golfers in order Similar to grid 204, grid block 506 may have a logo for the tournament, such as the Masters Logo. The blocks would represent possible outcomes of the holes, such as, for example, block 508 may represent a par for the second golfer on the 8^{th} hole, block 510 may represent an eagle for the 4^{th} golfer on the 13^{th} hole, etc FIG. 6 shows a game grid associated with an event, rather than a sports game For example, game grid 600 may represent an airplane schedule game to be played at the airport. In this case, columns 602 may represent flight numbers and rows 604 may, for simplicity, represent arrival and departures. In this case, block 606 may indicate a prize if flight 7012 departs on time Block 608 indicates a prize is awarded if flight 24 arrives with a ½× hour delay

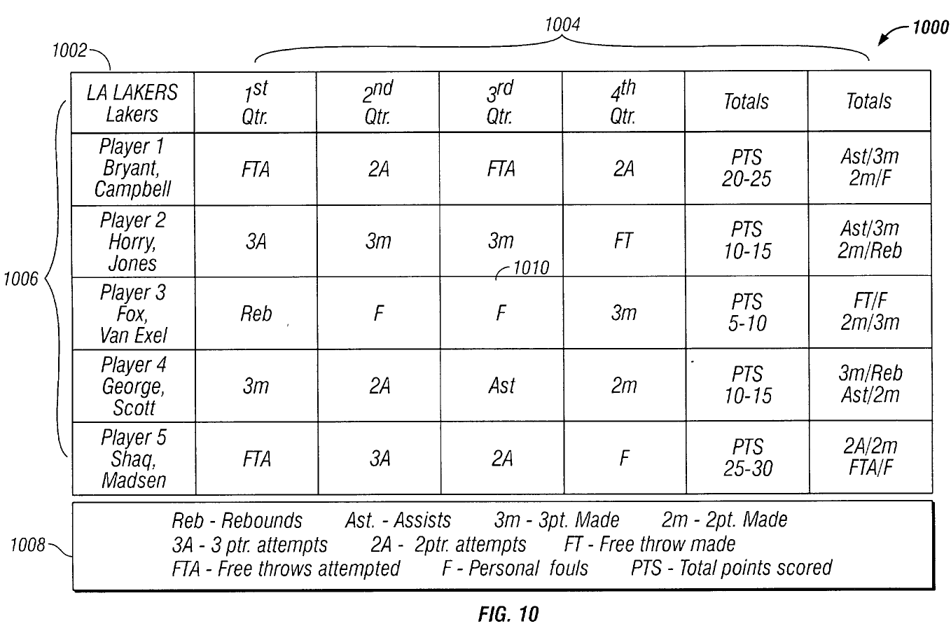

FIGS. 10, 11, and 12 provide still other non-limiting examples of the present invention FIG. 10 shows a sample grid 1000 for a basketball game In this case, the grid identifies an L A Lakers game in box 1002, but could be another professional team, a college team (such as the Duke Blue Devils), a final four team, a high school team, or the like As shown, grid 1000 contains columns 1004 for quarters and game totals. A row for half time results, results after a particular number of minutes played, or the like could be provided also The grid 1000 contains rows 1006 for individual players, such as Kobe Bryant. But rows 1006 could represent positions, such as shooting guard or power forward. FIG. 10 also includes a sample legend 1008 that can be used with grid 1000. In this case, prizes may be awarded if player 3, shown as Fox or Van Exel commit a particular number of fouls in the 3^{rd} quarter, grid box 1010

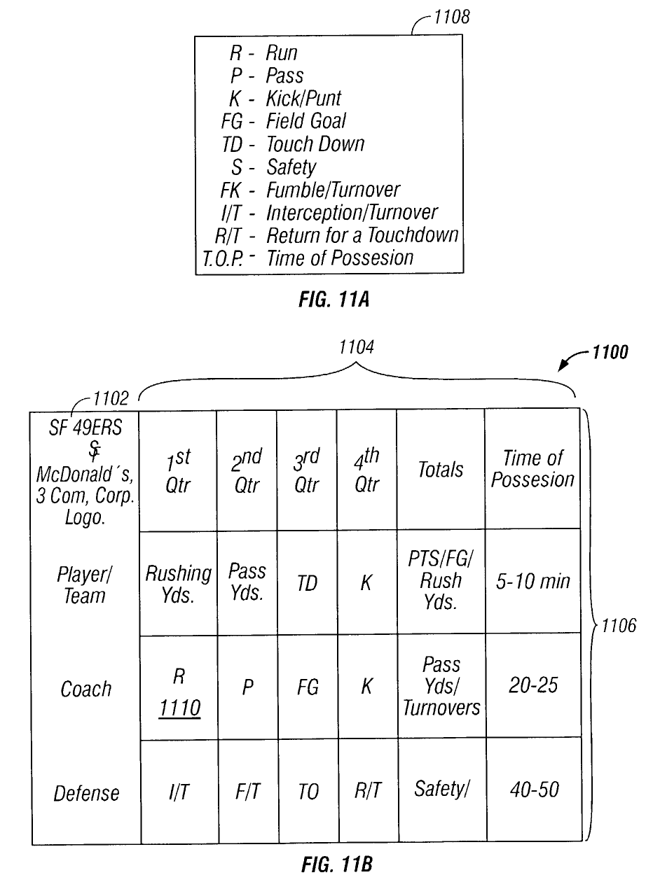

FIG. 11 shows another sample game grid 1100 Game grid 1100 is set up for a football game Grid 1100 indicates in block 1102 that the game is set up for the San Francisco 49ers professional football team, but college teams, high school, POP Warner teams, or the like could be used Similar to basketball, football is organized in quarters represented by columns 1104 Of course columns 1104 could represent total minutes into the game, number of minutes for a particular quarter, time after the two minute warning, or the like Rows 1106 can represent particular players, such as the quarterback, for example, Jeff Garcia, the running back, for example, Garrison Hearst, the wide receiver, for example, Terrell Owens, the Coach, for example, Steve Mariucci. Thus, a winning ticket may be if the coach calls 10 running plays in the first quarter, as shown by grid block 1110

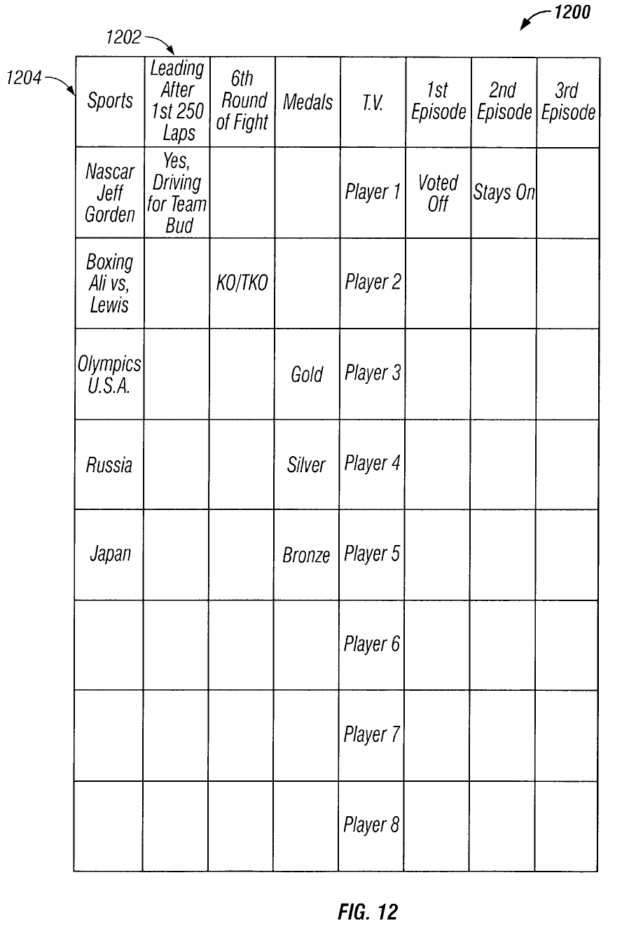

Finally, while the above examples show each game grid associated with a single sport or event, it would be possible to combine multiple events on a single game ticket. For example FIG. 12 shows a game grid 1200 Grid 1200 is set up for a combination sport/television game play Thus, columns 1202 having headings relating to the event and the result, while the rows 1204 relate to particular players or people that can establish the result Grid 1200 thus has a sport column, which includes rows for Nascar, Boxing, Olympic events, etc Grid 1200 also has a television column for shows, such as Survivor, with each row representing players Appropriate legends would be provided for the combination grid Of course, each sport or event listed in combination grid 1200 could be a separate game grid. Further, the individual grids identified above could be combined into combination grids

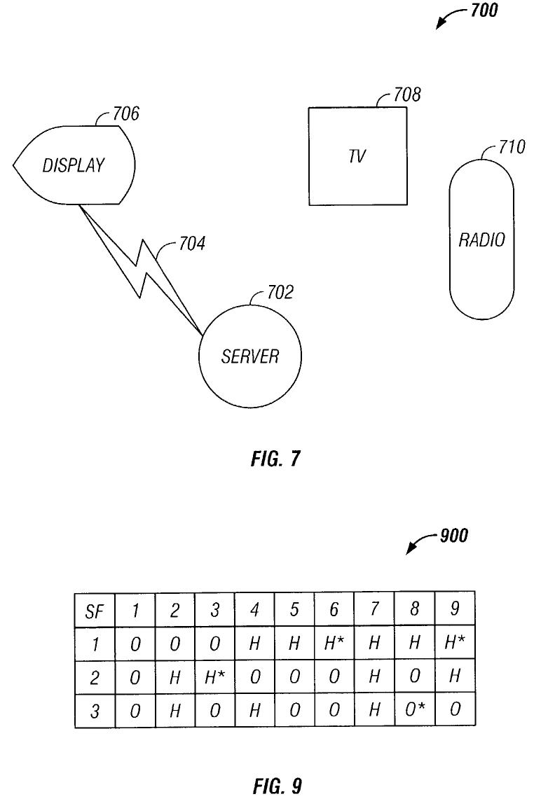

While the present invention should increase park attendance, the game can also be used to increase broadcast audiences FIG. 7 shows a system 700 illustrative of the present invention System 700 includes a server 702, a communication link 704, and a display 706, such as a graphical user interface (GUI) Display 706 can reside on a user's personal computer, be connected to a TV monitor, or the like Server 702 contains software and modules for running a game in accordance with the present invention. Communication link 704 connects server 702 and display 706. Communication link 704 could be a cable connection, a fiber connection, a bus connection, a wireless connection or the like depending on the overall system configuration In particular, display 706 and server 702 could be separate units, such as the operation between a user terminal and a server over the Internet Alternatively, server 702 could be a processor associated with display 706, such as a personal computer, with the communication link being conventional bus protocols. While shown as separate, display 706 could be incorporated into a TV 708 or radio 710 to facilitate play during the broadcast of a sport game or event Further, the present invention would be ideal for implementation on convergent systems associated with interactive television

As can be seen, the above game potentially increases the incentive for fans or viewers to attend the event venue or watch/listen to an event broadcast. One potential drawback of the above, is that tickets or game pieces potentially could be redeemed without complete attendance or viewing by the fan Redeeming winning tickets for prize coupons at the ball park is one of many ways this potential problem can be inhibited if not prevented For the on-line or computer gaming methodology, requiring the player to click or otherwise respond within a time frame of the prize winning event provides another way of inhibiting the potential problem One of ordinary skill in the art would recognize, however, many checks can be provided, such as monitoring TV or radio viewing, using other checks, etc.

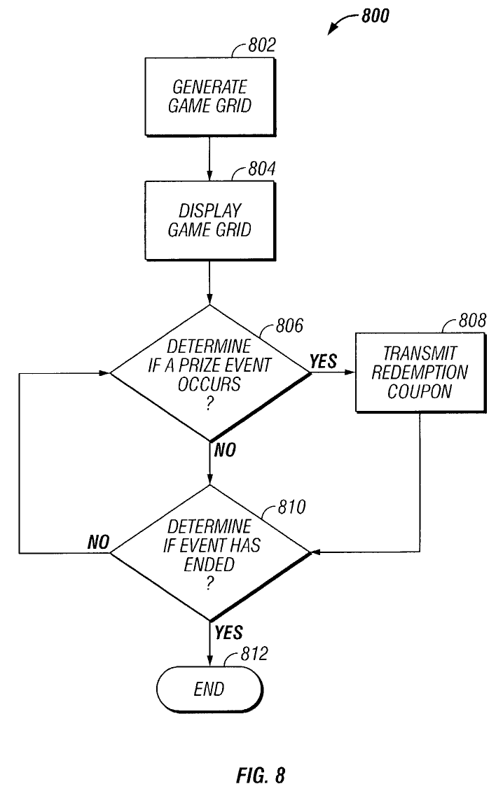

FIG. 8 illustrates a flowchart 800 that may be employed by a system 700 in accordance with the present invention First, a processor generates a game grid, step 802. After the game grid is generated, the processor (or a different processor) causes the display to display the game grid to the viewer or player, step 804 Ideally, the game grid is displayed during the entire event; however, the game grid could be displayed intermittently During the event, a determination is made whether a prize event occurs, step 806. If a prize event occurs, then the processor (which could be the processor that originally transmitted the game grid) transmits a redemption coupon, step 808. After the transmission of the redemption coupon, or if it is determined a prize event did not occur, it is determined if the event has ended, step 810 If the event has not ended, the system continues to determine whether prize events occur Otherwise, the game ends, step 812.

Many variations of the basic game are possible For example, instead of transmitting a prize coupon on each event, the processor could tally the prize events for each game grid and transmit a final redemption coupon. Alternatively, points could be awarded for events and the viewer could select prizes based on points, similar to credit card incentive programs

As mentioned above, a desirable option for the methodology would be a broadcast check step In context, broadcast check means determining whether the player is actually viewing or listening to the event while playing the game Many interactive television systems have means and mechanisms to verify viewing, and those conventional methods could be employed. Monitoring a broadcast to the game player's television or radio could also perform verification of viewing. Alternatively, the system could require a player to transmit a signal indicating the player believes a prize event occurred, by sending an email or a click response on a graphical user interface. To ensure false prizes are not awarded, the processor would have to verify the player's game grid did in fact have a prize event. The check only needs to be performed on initiation of the player, however

While the invention has been particularly shown and described with reference to embodiments thereof, it will be understood by those skilled in the art that various other changes in the form and details may be made without departing from the spirit and scope of the invention

We claim

1. An apparatus for gaming, comprising
a game grid,
the game grid comprising
at least one row,
at least one column, and
at least one grid block resides at least one intersection of the at least one row and the at least one column;
each of the at least one grid block representing a defined time that will occur during the event, and
each of the at least one grid block having a predetermined event occurrence that may occur at the defined time, wherein
at least one prize is awarded if the predetermined event occurs at the defined time

2. The apparatus according to claim 1, wherein the game grid resides on an event ticket

3. The apparatus according to claim 1, wherein the game grid is displayed one at least on monitor.

4. The apparatus according to claim 1, wherein the event comprises a sporting event

5. The apparatus according to claim 4, wherein
the sporting event comprises at least one of a baseball game, a hockey game, a golf match, a football game, a soccer game, a basketball game, a tennis match, and a lacrosse game.

6. The apparatus according to claim 3, further comprising
a processor, and
a communication link between the processor and the monitor,
the processor comprising
a game grid generator, and
a memory,
such that the game grid generator generates a game grid and the generated game grid is displayed on the monitor

7. The apparatus according to claim 6, further comprising:
a verifier capable of verifying a player is receiving at least one broadcast of the event

8. The apparatus according to claim 7, wherein the verifier includes a radio button on a graphical user interface

9. The apparatus according to claim 2, wherein the ticket includes a prize section indicative of at least one prize that can be won

10. The apparatus according to claim 1, further comprising
an indicator that indicates which specific times of the at least one specific time during which a prize event may occur

11. The apparatus according to claim 1, wherein the at least one prize is awarded at the defined time that is randomly determined.

12. The apparatus according to claim 1, wherein the at least one prize is awarded at the defined time that is formalistically determined.

13. A method of gaming comprising the steps of
providing a game grid having a plurality of grid blocks, each of the plurality of grid blocks representing a defined time in an event,
inserting at least one predetermined outcome into the plurality of grid blocks,
comparing the defined time in an event to the predetermined outcome on the game grid;
determining whether a match between the event and the game grid exists; and
awarding a prize if it is determined a match occurred.

14. The method according to claim 13, wherein the providing step is accomplished by displaying the game grid on a graphical user interface.

15. The method according to claim 13, wherein the inserting step includes random insertion of outcomes into the plurality of grid blocks

16. The method according to claim 13, wherein the inserting step includes formalistic insertion of outcomes into the plurality of grid blocks

17. The method according to claim 13, wherein the event is one of a sporting event and a non-sporting event.

18. The method according to claim 17, wherein the sporting event is one of a baseball game, a hockey game, a golf match, a football game, a soccer game, a basketball game, a tennis match, and a lacrosse game.

19. The method according to claim 14, further comprising the step of verifying viewing of the event

20. An apparatus for gaming, comprising
means for generating a game grid, the game grid comprises at least one grid block that represents a defined time during an event,
means for inserting in the at least one grid block at least one predetermined occurrence that may happen during the event,
means for determining whether the predetermined occurrence happens during the defined time, and
means for awarding a prize when it is determined that the predetermined occurrence happened during the defined time.
